(19) United States
(12) Patent Application Publication
(10) Pub. No.: US 2012/0064340 A1
(43) Pub. Date: Mar. 15, 2012

(54) PRESSURE-SENSITIVE ADHESIVE OPTICAL FILM, METHOD FOR PRODUCING THE ADHESIVE OPTICAL FILM, IMAGE DISPLAY, ADHESIVE COATING LIQUID, AND METHOD FOR PRODUCING THE ADHESIVE COATING LIQUID

(75) Inventors: Kunihiro Inui, Ibaraki-shi (JP); Masayuki Satake, Ibaraki-shi (JP); Toshitsugu Hosokawa, Ibaraki-shi (JP); Takaaki Ishii, Ibaraki-shi (JP); Yoshiaki Kitani, Ibaraki-shi (JP); Toshitaka Takahashi, Ibaraki-shi (JP); Yousuke Makihata, Ibaraki-shi (JP); Yoshihiro Kitamura, Ibaraki-shi (JP)

(73) Assignee: NITTO DENKO CORPORATION, Ibaraki-shi, Osaka (JP)

(21) Appl. No.: 13/320,851

(22) PCT Filed: May 12, 2010
(86) PCT No.: PCT/JP2010/058043

§ 371 Date: Nov. 16, 2011

(30) Foreign Application Priority Data
Jun. 5, 2009 (JP) 2009-136539

(51) Int. Cl. B32B 7/12; C09J 133/14; C09J 133/08; B05D 5/10; B05D 3/00

(52) U.S. Cl. 428/355 AC; 428/343; 427/162; 524/560; 524/558

(57) ABSTRACT

A pressure-sensitive adhesive optical film of the invention includes an optical film; and a pressure-sensitive adhesive layer placed on at least one side of the optical film, wherein the pressure-sensitive adhesive layer is a product formed by applying a pressure-sensitive adhesive coating liquid having a dissolved oxygen concentration of 0.02 to 3 mg/L and then drying the pressure-sensitive adhesive coating liquid. The pressure-sensitive adhesive optical film can satisfy heat durability, humidity durability, and high contrast.

### TECHNICAL FIELD

The invention relates to a pressure-sensitive adhesive optical film and a method for production thereof. The invention also relates to an image display such as a liquid crystal display or an organic electroluminescence (EL) display produced using the pressure-sensitive adhesive optical film. Examples of the optical film that may be used include a polarizing plate, a retardation plate, an optical compensation film, a brightness enhancement film, and a laminate thereof. The invention further relates to a pressure-sensitive adhesive coating liquid for use in forming the pressure-sensitive adhesive layer of the pressure-sensitive adhesive optical film and to a method for production thereof.

### BACKGROUND ART

In a process of forming an image display such as a liquid crystal display, various optical films such as polarizing plates and retardation plates used to form the device are bonded to an adherend such as a liquid crystal cell with a pressure-sensitive adhesive layer interposed therebetween. In many cases, a pressure-sensitive adhesive is previously provided in the form of a pressure-sensitive adhesive layer on one side of an optical film, because it has some advantages such as the ability to instantaneously fix the optical film to a display panel such as a liquid crystal cell and no need to use a drying process for the fixation of the optical film.

The pressure-sensitive adhesive is required not to cause pressure-sensitive adhesive-included defects such as forming and peeling in a durability test under heating, humidifying or the like, which is generally performed as an environmental acceleration test.

The liquid crystal display and the like are required to display high-contrast images. In the liquid crystal display or the like, images are displayed through optical films and pressure-sensitive adhesive layers. To display high-contrast images, therefore, pressure-sensitive adhesive layers are also required to have a high-quality coating appearance. For example, a defect such as an air bubble or a foreign body present in a pressure-sensitive adhesive layer may cause a defect in image display, so that the commercial value of the image display may be reduced.

Conventionally, pressure-sensitive adhesives such as organic solvent type pressure-sensitive adhesives and water dispersion type pressure-sensitive adhesives have been used to form pressure-sensitive adhesive layers for the above applications. In recent years, there has been a need to reduce the use of organic solvents in view of environmental loading, and therefore, there has been a need to replace organic solvent type pressure-sensitive adhesives with aqueous dispersion type pressure-sensitive adhesives which are produced using water as a dispersion medium and contain a pressure-sensitive adhesive component dispersed in water. For example, an aqueous dispersion type acryl-based pressure-sensitive adhesive produced with a phosphate monomer is proposed in view of heat resistance or humidity resistance (Patent Document 1). Unfortunately, such an aqueous dispersion type pressure-sensitive adhesive, which contains not only a pressure-sensitive adhesive component but also a surfactant for dispersing the pressure-sensitive adhesive component into water, has a tendency to foam easily, and the pressure-sensitive adhesive layer obtained using such an aqueous dispersion type pressure-sensitive adhesive is more likely to be contaminated with fine air bubbles and therefore less likely to achieve high contrast. In addition, fine air bubbles are not preferred in terms of heat durability, because they can serve as nuclei for heat-induced foaming in a heat durability test. Particularly, in recent years, as the size of image displays has increased, even a pressure-sensitive adhesive layer to be applied to a large-size optical film has been required to be formed with a good coating appearance and a high yield in view of production efficiency. This makes it difficult to use aqueous dispersion type pressure-sensitive adhesives in optical applications.

On the other hand, it is proposed that air bubbles present in various treatment liquids such as pressure-sensitive adhesives including aqueous dispersion type acryl-based pressure-sensitive adhesives should be degassed by automatic control and that the degassing by the automatic control should be performed based on the dissolved oxygen concentration value of the treatment liquid (Patent Document 2).

### PRIOR ART DOCUMENTS

### Patent Documents

Patent Document 1: JP-A No. 2007-186661
Patent Document 2: JP-A No. 2006-102608

### SUMMARY OF THE INVENTION

### Problems to be Solved by the Invention

Unfortunately, production of a pressure-sensitive adhesive optical film capable of satisfying heat durability, humidity durability, and high contrast is difficult only by degassing a pressure-sensitive adhesive so that its dissolved oxygen concentration can be as close to zero as possible in the process of forming a pressure-sensitive adhesive layer for the pressure-sensitive adhesive optical film.

An object of the invention is to provide a pressure-sensitive adhesive optical film capable of satisfying heat durability, humidity durability, and high contrast and to provide a method for manufacturing such a pressure-sensitive adhesive optical film. Another object of the invention is to provide a pressure-sensitive adhesive coating liquid for use in forming the pressure-sensitive adhesive layer of such a pressure-sensitive adhesive optical film and a method for manufacture thereof.

A further object of the invention is to provide an image display produced using such a pressure-sensitive adhesive optical film.

### Means for Solving the Problems

As a result of earnest studies to solve the above problems, the inventors have found that it is difficult to satisfy heat durability, humidity durability, and high contrast only by degassing a pressure-sensitive adhesive so that its dissolved oxygen concentration can be as close to zero as possible in the process of forming a pressure-sensitive adhesive layer for a pressure-sensitive adhesive optical film, but when a pressure-sensitive adhesive coating liquid having a minimum (given) dissolved oxygen concentration is used, heat durability, humidity durability, and high contrast can be satisfied, and therefore, it is important for a pressure-sensitive adhesive coating liquid to have a dissolved oxygen concentration in a predetermined range. Based on the finding, the inventors have found the pressure-sensitive adhesive optical film and other features described below to accomplish the invention.

The invention relates to a pressure-sensitive adhesive optical film, including:

an optical film; and

a pressure-sensitive adhesive layer placed on at least one side of the optical film, wherein

the pressure-sensitive adhesive layer is a product formed by applying a pressure-sensitive adhesive coating liquid having a dissolved oxygen concentration of 0.02 to 3 mg/L and then drying the pressure-sensitive adhesive coating liquid.

When the dissolved oxygen concentration of the pressure-sensitive adhesive coating liquid is controlled in the specified range, a pressure-sensitive adhesive optical film capable of satisfying heat durability, humidity durability, and high contrast is obtained. The concentration of dissolved oxygen in a solution has been used as a guide for replacement with nitrogen gas from the standpoint of polymerization inhibition during emulsion polymerization or used as a reference for inhibition of curing (polymerization) of ultraviolet-curable materials. However, there has been no information suggesting that control of the concentration of dissolved oxygen in a pressure-sensitive adhesive coating liquid (particularly, an aqueous dispersion type pressure-sensitive adhesive) may make it possible to obtain a pressure-sensitive adhesive layer with a good coating appearance and to obtain a pressure-sensitive adhesive optical film satisfying heat durability, humidity durability, and high contrast.

Heat durability is related to the presence or absence of air bubbles in a heating environment, and the concentration of dissolved oxygen in the pressure-sensitive adhesive coating liquid is preferably as low as possible. On the other hand, if the dissolved oxygen concentration is more than 3 mg/L, air bubbles present in the pressure-sensitive adhesive coating liquid may serve as starting points (nuclei for foaming) after the formation of a pressure-sensitive adhesive layer so that air bubbles may be frequently produced in the heating environment, which is not preferred.

Humidity durability is related to whether or not peeling of a pressure-sensitive adhesive layer occurs in a humid environment, and even when the pressure-sensitive adhesive coating liquid has a high dissolved oxygen concentration, the pressure-sensitive adhesive layer is less likely to peel. On the other hand, it is considered that if the dissolved oxygen concentration is lower than 0.02 mg/L, the oxygen content may be too low also after the formation of the pressure-sensitive adhesive layer so that residual radicals, which have been present in the pressure-sensitive adhesive coating liquid, may be activated, although the reason for that is not clear. It is also considered that as a result, the residual radicals may react with the residual monomer to form a low-molecular-weight polymer (oligomer) so that peeling of the pressure-sensitive adhesive layer may occur. However, it will be understood that this discussion is not intended to limit or restrict the invention at all.

High contrast is related to no degradation in contrast due to the formation of the pressure-sensitive adhesive layer. In general, vigorous stirring is performed during degassing to reduce the concentration of dissolved oxygen in the pressure-sensitive adhesive coating liquid to less than 0.02 mg/L. However, if stirring is performed too much, for example, a high shearing force will be applied to emulsion particles in an aqueous dispersion type pressure-sensitive adhesive coating liquid (emulsion), so that the state of the dispersion (emulsion) will be made unstable. In general, emulsion particles in a stable dispersion are individually and uniformly dispersed, while emulsion particles in an unstable dispersion can form a secondary or tertiary aggregate, which will make the dispersed state non-uniform. If such an unstable dispersion is applied and dried to form a pressure-sensitive adhesive layer, the surface of the pressure-sensitive adhesive layer will have poor smoothness due to the aggregate, so that a poor contrast may be produced. Also in the case of an organic solvent type pressure-sensitive adhesive, degassing for a long time or under a high degree of vacuum is necessary to reduce the dissolved oxygen concentration of the pressure-sensitive adhesive coating liquid to less than 0.02 mg/L. In such a case, the organic solvent or the reactive diluent is vaporized in the degassing process, so that the viscosity of the pressure-sensitive adhesive coating liquid increases, which will degrade the surface smoothness of the pressure-sensitive adhesive coating layer and degrade contrast. On the other hand, if the dissolved oxygen concentration is higher than 3 mg/L, apparent air bubbles (large air bubbles) in the pressure-sensitive adhesive layer formed may cause diffuse reflection to degrade contrast.

In the pressure-sensitive adhesive optical film, for example, an aqueous dispersion type pressure-sensitive adhesive including a dispersion containing at least a base polymer dispersed in water may be used as the pressure-sensitive adhesive coating liquid.

When the pressure-sensitive adhesive coating liquid is an aqueous dispersion type pressure-sensitive adhesive, the dissolved oxygen concentration of the aqueous dispersion type pressure-sensitive adhesive is preferably from 0.05 to 2 mg/L, more preferably from 0.1 to 1 mg/L, even more preferably from 0.1 to 0.5 mg/L from the standpoint of heat durability, humidity durability, and high contrast.

A (meth)acryl-based polymer is preferable as a base polymer in the aqueous dispersion type pressure-sensitive adhesive. The (meth)acryl-based polymer as the base polymer is preferably a product of emulsion polymerization.

In the pressure-sensitive adhesive optical film, for example, an organic solvent type pressure-sensitive adhesive including a solution containing at least a base polymer dissolved in an organic solvent may be used as the pressure-sensitive adhesive coating liquid.

When the pressure-sensitive adhesive coating liquid is an organic solvent type pressure-sensitive adhesive, the dissolved oxygen concentration of the organic solvent type pressure-sensitive adhesive is preferably from 0.1 to 2 mg/L, more preferably from 0.5 to 1 mg/L from the standpoint of heat durability, humidity durability, and high contrast.

The organic solvent type pressure-sensitive adhesive is free of a hydrophilic component such as an emulsifying agent in contrast to the aqueous dispersion type pressure-sensitive adhesive. Therefore, the pressure-sensitive adhesive layer formed using the organic solvent type pressure-sensitive adhesive has a water absorption rate lower than that of the pressure-sensitive adhesive layer formed using the aqueous dispersion type pressure-sensitive adhesive. Foaming against heat durability is influenced not only by the dissolved oxygen concentration but also by the water absorption rate of the pressure-sensitive adhesive layer. Specifically, the higher the water absorption rate of the pressure-sensitive adhesive layer, the more likely foaming will occur. Therefore, since the water absorption rate of the pressure-sensitive adhesive layer formed using the organic solvent type pressure-sensitive adhesive is lower than that of the pressure-sensitive adhesive layer formed using the aqueous dispersion type pressure-sensitive adhesive, the heat durability (foaming) of the pressure-sensitive adhesive layer formed using the organic solvent type pressure-sensitive adhesive is less susceptible to the water absorption rate even at the same dissolved oxygen concentration, which means that accordingly, a higher dissolved oxygen concentration is acceptable in the preferred range.

The invention also related to a method for manufacturing the above pressure-sensitive adhesive optical film, including the steps of:

(1) degassing a pressure-sensitive adhesive coating liquid so that the coating liquid has a dissolved oxygen concentration of 0.02 to 3 mg/L;

(2) applying the pressure-sensitive adhesive coating liquid, which has undergone the degassing step (1), to one or both sides of a base substrate; and

(3) drying the applied pressure-sensitive adhesive coating liquid to form a pressure-sensitive adhesive layer.

The invention also related to an image display, including at least one piece of the above pressure-sensitive adhesive optical film.

The invention also related to a pressure-sensitive adhesive coating liquid for use in forming a pressure-sensitive adhesive layer of a pressure-sensitive adhesive optical film including an optical film and the pressure-sensitive adhesive layer placed on at least one side of the optical film,

the pressure-sensitive adhesive coating liquid has a dissolved oxygen concentration of 0.02 to 3 mg/L.

The invention also related to a method for producing the above pressure-sensitive adhesive coating liquid, including degassing a pressure-sensitive adhesive coating liquid so that the coating liquid has a dissolved oxygen concentration of 0.02 to 3 mg/L.

### Effects of the Invention

The pressure-sensitive adhesive optical film of the invention, which is produced with a pressure-sensitive adhesive coating liquid with a controlled dissolved oxygen concentration of 0.05 to 3 mg/L, satisfies heat durability, humidity durability, and high contrast.

Concerning the dissolved oxygen concentration during emulsion polymerization in the process of producing an acryl-based polymer emulsion by emulsion polymerization, 1.5 ppm (1.5 mg/L) and 4 ppm (4 mg/L) are disclosed in JP-A Nos. 2005-42061 and 2009-19181, respectively. However, the dissolved oxygen concentration of the emulsion resulting from the emulsion polymerization described in the publications must be higher than that during the emulsion polymerization, and the product whose dissolved oxygen concentration is controlled to 0.05 to 3 mg/L according to the invention is distinguishable from such a conventional emulsion resulting from emulsion polymerization.

As described above, the pressure-sensitive adhesive optical film is obtained by performing the degassing step (1) to a pressure-sensitive adhesive coating liquid so that the specified dissolved oxygen concentration can be achieved and then performing the applying step (2) and the pressure-sensitive adhesive layer forming step (3).

### BRIEF DESCRIPTION OF DRAWINGS

FIG. 1 is a schematic diagram illustrating an exemplary system for applying a pressure-sensitive adhesive in a case where a reduced pressure feeding apparatus is used to feed a pressure-sensitive adhesive coating liquid in the process of manufacturing the pressure-sensitive adhesive optical film of the invention; and

FIG. 2 is a flow chart illustrating the operation process performed in the pressure-sensitive adhesive applying system.

### EMBODIMENTS FOR CARRYING OUT THE INVENTION

The pressure-sensitive adhesive layer of the invention is formed by applying a pressure-sensitive adhesive coating liquid whose dissolved oxygen concentration is controlled to a predetermined value and then drying it.

Materials of the pressure-sensitive adhesive to be used may be of any type such as a rubber-based pressure-sensitive adhesive, an acryl-based pressure-sensitive adhesive, a silicone-based pressure-sensitive adhesive, a urethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, or a cellulose-based pressure-sensitive adhesive.

The pressure-sensitive adhesive coating liquid to be used may be in various forms such as an aqueous dispersion type pressure-sensitive adhesive, an organic solvent type pressure-sensitive adhesive, and a hot melt type pressure-sensitive adhesive. The form of the pressure-sensitive adhesive may be selected depending on the type of the pressure-sensitive adhesive. Each of the above pressure-sensitive adhesives may also be used in the form of a radiation-curable pressure-sensitive adhesive.

In view of environmental loading, an aqueous dispersion type pressure-sensitive adhesive is preferably used as the pressure-sensitive adhesive coating liquid. The aqueous dispersion type pressure-sensitive adhesive is an aqueous dispersion as mentioned above, which can be advantageously used even when it has a high viscosity in the range of 100 mPa·s to 10,000 mPa·s. The aqueous dispersion type pressure-sensitive adhesive having such a high viscosity is suitable for forming a pressure-sensitive adhesive layer. The aqueous dispersion type pressure-sensitive adhesive preferably has a viscosity in the range of 1,000 mPa·s to 5,000 mPa·s. The viscosity of the aqueous dispersion type pressure-sensitive adhesive is the value measured using a viscometer manufactured by HAAKE (RheoStress 1) under the conditions of a temperature of 30° C. and a shear rate of 1 (1/s).

The aqueous dispersion type pressure-sensitive adhesive is a dispersion containing at least a base polymer dispersed in water. While the dispersion to be used generally contains a base polymer dispersed in the presence of a surfactant, a dispersion containing a self-dispersible base polymer dispersed by itself in water may also be used.

The base polymer in the dispersion may be a product obtained by emulsion polymerization or dispersion polymerization of a monomer or monomers in the presence of a surfactant.

The dispersion may also be produced by dispersing and emulsifying a separately produced base polymer in water in the presence of an emulsifying agent. The emulsifying method may be a method including uniformly dispersing and emulsifying a polymer and an emulsifying agent, which may or may not have previously been melted by heating, with water using a mixer such as a pressure kneader, a colloid mill, or a high-speed stirring shaft, under high shearing, and then cooling the mixture in such a manner that the dispersed particles do not fuse or aggregate, so that a desired aqueous dispersion is obtained (high-pressure emulsification method); or a method including previously dissolving a polymer in an organic solvent such as benzene, toluene, or ethyl acetate, then adding the emulsifying agent and water to the solution, uniformly dispersing and emulsifying the mixture typically using a high-speed homogenizer under high shearing, and then removing the organic solvent by a heat treatment under reduced pressure or other methods to form a desired aqueous dispersion (solvent solution method).

The organic solvent type pressure-sensitive adhesive is a solution containing at least a base polymer dissolved in an organic solvent. The base polymer in the solution may be a product obtained by solution polymerization of a monomer or monomers in an organic solvent. The solution may also be produced by dissolving a base polymer in an organic solvent, in which the base polymer has been produced separately. The type of the organic solvent to be used may be selected depending on the type of the base polymer.

Examples of the organic solvent include aromatic hydrocarbons such as benzene, toluene, and xylene; esters such as ethyl acetate; halogenated hydrocarbons such as chloroform, dichloromethane, dichloroethane, tetrachloroethane, trichloroethylene, tetrachloroethylene, and chlorobenzene; ketones such as acetone, methyl ethyl ketone, methyl isobutyl ketone, cyclohexanone, and cyclopentanone; and others such as N-methyl-2-pyrrolidone, pyridine, tetrahydrofuran, dimethylformamide, dimethylacetamide, dimethyl sulfoxide, acetonitrile, butyronitrile, and carbon disulfide.

Among the pressure-sensitive adhesives, an acryl-based pressure-sensitive adhesive is preferably used in an embodiment of the invention, because it has a high level of optical transparency and weather resistance or heat resistance and exhibits appropriate wettability and pressure-sensitive adhesive properties such as appropriate cohesiveness and tackiness. The pressure-sensitive adhesive coating liquid is preferably an aqueous dispersion type acryl-based pressure-sensitive adhesive.

The acryl-based pressure-sensitive adhesive includes, as a base polymer, a (meth)acryl-based polymer having an alkyl (meth)acrylate monomer unit in the main skeleton. As used herein, the term “alkyl (meth)acrylate ester” means alkyl acrylate ester and/or alkyl methacrylate ester, and “(meth)” is used in the same meaning in the description.

The alkyl (meth)acrylate ester used to form the main skeleton of the (meth)acryl-based polymer may have a straight or branched chain alkyl group of 1 to 18 carbon atoms. For example, the alkyl group may be methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, octadecyl, or the like. These may be used alone or in any combination. The average carbon number of such alkyl groups is preferably from 3 to 9.

An aromatic ring-containing alkyl (meth)acrylate ester such as phenoxyethyl (meth)acrylate may also be used. A polymer of such an aromatic ring-containing alkyl (meth)acrylate ester may be used in a mixture with any of the exemplary (meth)acryl-based polymers. In view of transparency, however, such an aromatic ring-containing (meth)acrylate ester is preferably used to form a copolymer with the alkyl (meth)acrylate ester.

In order to improve tackiness or heat resistance, one or more copolymerizable monomers having an unsaturated double bond-containing polymerizable functional group such as a (meth)acryloyl group or a vinyl group may be introduced into the (meth)acryl-based polymer by copolymerization. Examples of such copolymerizable monomers include hydroxyl group-containing monomers such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate; carboxyl group-containing monomers such as (meth)acrylic acid, carboxyethyl (meth)acrylate, carboxypentyl (meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth) acryloyloxynaphthalenesulfonic acid; and phosphate group-containing monomers such as 2-hydroxyethylacryloyl phosphate and phosphate esters of polyalkylene oxide (meth)acrylate.

Examples of such monomers for modification also include (N-substituted) amide monomers such as (meth)acrylamide, N,N-dimethyl(meth)acrylamide, N-butyl(meth)acrylamide, N-methylol(meth)acrylamide, N-methylolpropane(meth)acrylamide, and N-hydroxyethyl(meth)acrylamide; alkylaminoalkyl (meth)acrylate monomers such as aminoethyl (meth)acrylate, N,N-dimethylaminoethyl (meth)acrylate, and tert-butylaminoethyl (meth)acrylate; alkoxyalkyl (meth)acrylate monomers such as methoxyethyl (meth)acrylate and ethoxyethyl (meth)acrylate; succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acrvioylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N2-ethylhexylitaconimide, N-cyclohexylitaconimide, and N-laurylitaconimide.

Examples of modification monomers that may also be used include vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidvl (meth)acrylate; glycol acrylic ester monomers such as polyethylene glycol (meth)acrylate, polypropylene glycol (meth)acrylate, methoxyethylene glycol (meth)acrylate, and methoxypolypropylene glycol (meth)acrylate; and acrylate ester monomers such as tetrahydrofurfuryl (meth)acrylate, fluoro(meth)acrylate, silicone (meth)acrylate, and 2-methoxyethyl acrylate. Examples also include isoprene, butadiene, isobutylene, and vinyl ether.

Examples of copolymerizable monomers that may also be used include polyfunctional monomers having two or more unsaturated double bonds such as those in (meth)acryloyl groups or vinyl groups, which include (meth)acrylate esters of polyhydric alcohols, such as ethylene glycol di(meth)acrylate, diethylene glycol di(meth)acrylate, tripropylene glycol di(meth)acrylate, tetraethylene glycol di(meth)acrylate, 1,6-hexanediol di(meth)acrylate, bisphenol A diglycidvl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and compounds having a polyester, epoxy or urethane skeleton to which two or more unsaturated double bonds are added in the form of functional groups such as (meth)acryloyl groups or vinyl groups in the same manner as the monomer component, such as polyester (meth)acrylates, epoxy (meth)acrylates, and urethane (meth)acrylates.

Concerning the weight ratios of all monomer components, the alkyl (meth)acrylate ester should be a main component of the (meth)acryl-based polymer, and the content of the copolymerizable monomer used to form the (meth)acryl-based polymer is preferably, but not limited to, 0 to about 20%, more preferably about 0.1 to about 15%, even more preferably about 0.1 to about 10%, based on the total weight of all monomer components.

Among these copolymerizable monomers, hydroxyl group-containing monomers or carboxyl group-containing monomers are preferably used in view of tackiness or durability. When the aqueous dispersion type pressure-sensitive adhesive contains a crosslinking agent, these copolymerizable monomers can serve as a reactive site with the crosslinking agent. Such hydroxyl group-containing monomers or carboxyl group-containing monomers are highly reactive with intermolecular crosslinking agents and therefore are preferably used to improve the cohesiveness or heat resistance of the resulting pressure-sensitive adhesive layer.

When a hydroxyl group-containing monomer and a carboxyl group-containing monomer are added as copolymerizable monomers, these copolymerizable monomers may each be used in the above ratio. Specifically, a carboxyl group-containing monomer and a hydroxyl group-containing monomer are preferably added in an amount of 0.1 to 10% by weight and in an amount of 0.01 to 2% by weight, respectively. A carboxyl group-containing monomer is more preferably 0.2 to 8% by weight, even more preferably 0.6 to 6% by weight. A hydroxyl group-containing monomer is more preferably 0.03 to 1.5% by weight, even more preferably 0.05 to 1% by weight.

The method for producing such a (meth)acryl-based polymer may be appropriately selected from known methods including various radical polymerization methods such as solution polymerization, bulk polymerization, emulsion polymerization, suspension polymerization, and dispersion polymerization. The resulting (meth)acryl-based polymer may be any of a random copolymer, a block copolymer, a graft copolymer, etc.

In the solution polymerization, an organic solvent such as ethyl acetate or toluene should be used as a polymerization solvent. In a specific example of the solution polymerization, a polymerization initiator is added, and the reaction is generally performed under the conditions of a temperature of about 50 to about 70° C. and a time period of about 5 to about 30 hours under a stream of inert gas such as nitrogen gas.

The emulsion polymerization may be performed in the presence of the emulsifying agent by a conventional technique using an appropriate polymerization initiator, so that an aqueous dispersion can be prepared. The emulsion polymerization may be performed according to general batch polymerization, continuous dropping polymerization, intermittent dropping polymerization, or the like. The polymerization may be performed at a temperature of about 30 to about 90° C.

In the radical polymerization, any appropriate polymerization initiator, chain transfer agent, emulsifying agent, etc. may be selected and used. It will be understood that the weight average molecular weight of the (meth)acryl-based polymer can be controlled by the amount of the polymerization initiator or chain transfer agent used or the reaction conditions, and the amount to be used may be appropriately controlled depending on the their type.

Examples of the polymerization initiator include an azo initiator such as 2,2′-azobisisobutyronitrile, 2,2′-azobis(2-amidinopropane)dihydrochloride, and 2,2′-azobis(N,N′-dimethyleneisobutylamidine), 2,2′-azobis(2-methylpropionamidine)dihydrochloride, or 2,2′-azobis[N-(2-carboxyethyl)-2-methylpropionamidine]hydrate; a persulfate such as potassium persulfate or ammonium persulfate; a peroxide initiator such as benzoyl peroxide or tert-butyl hydroperoxide; and a redox initiator such as a combination of a persulfate and sodium hydrogen sulfite. If necessary, an appropriate chain transfer agent such as a mercaptan compound or a mercaptopropionate ester may be used to control the molecular weight of the resulting polymer.

An anionic emulsifying agent or a nonionic emulsifying agent, which has been used in emulsion polymerization, may be used without restriction as the emulsifying agent. Examples include anionic emulsifying agents such as sodium lauryl sulfate, ammonium lauryl sulfate, sodium dodecylbenzenesulfonate, sodium polyoxyethylene alkyl ether sulfate, and sodium polyoxyethylene alkyl phenyl ether sulfate; and nonionic emulsifying agents such as polyoxyethylene alkyl ether and polyoxyethylene alkyl phenyl ether. In both of the cases of the anionic emulsifying agent and the nonionic emulsifying agent, a radically-polymerizable emulsifying agent produced by introducing a reactive functional group such as a propenyl, allyl, or (meth)acryloyl group into an emulsifying agent is preferably used. For example, radically-polymerizable emulsifying agents are disclosed in JP-A Nos. 04-50204 and 04-53802.

The amount of the emulsifying agent to be used is preferably, but not limited to, from about 0.3 to about 5 parts by weight, more preferably from 0.7 to 4 parts by weight, based on 100 parts by weight of monomer components containing the alkyl (meth)acrylate ester as a main component.

In an embodiment of the invention, the (meth)acryl-based polymer to be used generally has a weight average molecular weight in the range of 1,000,000 to 3,000,000. In view of durability, particularly in view of heat resistance, the (meth)acryl-based polymer to be used preferably has a weight average molecular weight of 1,000,000 to 2,500,000, more preferably 1,700,000 to 2,500,000, even more preferably 1,800,000 to 2,500,000. A weight average molecular weight of less than 1,000,000 is not preferred in view of heat resistance. A weight average molecular weight of more than 3,000,000 is also not preferred, because such a weight average molecular weight may cause a reduction in bonding ability or adhering strength. The weight average molecular weight may refer to a polystyrene-equivalent weight average molecular weight as measured and calculated using GPC (gel permeation chromatography).

The aqueous dispersion type pressure-sensitive adhesive, the organic solvent type pressure-sensitive adhesive, or the like may be used in the form of a radiation-curable pressure-sensitive adhesive. The pressure-sensitive adhesive for use as a radiation-curable pressure-sensitive adhesive can be produced using a radiation-curable base polymer having a radiation-curable functional group such as a (meth)acryloyl group or a vinyl group, or produced by adding a reactive diluent to a base polymer (which may include the radiation-curable base polymer). An example of the radiation-curable pressure-sensitive adhesive also includes a product that contains a monomer or partial polymer thereof, capable of forming a base polymer, and can form a pressure-sensitive adhesive layer containing a base polymer when exposed to a radiation such as an electron beam or ultraviolet light (in this case, the monomer or the partial polymer thereof forms a base polymer). The radiation-curable pressure-sensitive adhesive may contain a polymerization initiator. While a description has been given of cases where a radiation-curable pressure-sensitive adhesive is used in the form of an aqueous dispersion or organic solvent type adhesive, a radiation-curable pressure-sensitive adhesive may also be used in the form of a solvent-free adhesive (including the case of a hot melt type).

The radiation-curable base polymer can be obtained by reaction of a base polymer having a functional group(a) with a compound having a functional group(b) reactive with the functional group(a) and also having a polymerizable carbon-carbon double bond such as a (meth)acryloyl or vinyl group. Examples of the functional group(a) and the functional group(b) include a carboxyl group, an acid anhydride group, a hydroxyl group, an amino group, an epoxy group, an isocyanate group, and an aziridine group, and any appropriate combination of the groups reactive with each other may be selected and used. The base polymer of the radiation-curable pressure-sensitive adhesive is also preferably an acryl-based polymer.

The reactive diluent to be used may be a radically-polymerizable monomer component and/or a radically-polymerizable oligomer component having at least one of the above radiation-curable functional groups.

Regarding to a pressure-sensitive adhesive layer formed of a radiation-curable pressure-sensitive adhesive, a resin forming the pressure-sensitive adhesive layer has low water absorption rate. Therefore, a standard, which is in the preferred range, of the dissolved oxygen concentration with respect to the heat durability (foaming) is higher than that of the pressure-sensitive adhesive layer formed using the aqueous dispersion type pressure-sensitive adhesive. In the radiation-curable pressure-sensitive adhesive, if a dissolved oxygen concentration of a pressure-sensitive adhesive coating liquid is low, oxygen prevention is hardly occurred, but depending on a material of an optical film (for example, a transparent protective film of a polarizer). Thus, contrasts of the optical film incline to decrease when the optical film is irradiated with radiation and damaged.

In an embodiment of the invention, the pressure-sensitive adhesive coating liquid may contain a crosslinking agent in addition to the base polymer (or in addition to the monomer or partial polymer thereof capable of forming a base polymer and the reactive diluent in the case of the radiation-curable type). In an acryl-based pressure-sensitive adhesive, the crosslinking agent for use in the adhesive may be a common crosslinking agent such as an isocyanate crosslinking agent, an epoxy crosslinking agent, an oxazoline crosslinking agent, an aziridine crosslinking agent, a carbodiimide crosslinking agent, or a metal chelate crosslinking agent. These crosslinking agents are effective in reacting with and crosslinking the functional group incorporated into the polymer by the use of the functional group-containing monomer.

While the content ratio between the base polymer and the crosslinking agent is not restricted, about 10 parts by weight or less (solid basis) of the crosslinking agent is generally added to 100 parts by weight (solid basis) of the base polymer. The content of the crosslinking agent is preferably from 0.001 to 10 parts by weight, more preferably from 0.01 to 5 parts by weight.

If necessary, the pressure-sensitive adhesive coating liquid according to an embodiment of the invention may further appropriately contain any of various additives such as tackifiers, plasticizers, fillers including glass fibers, glass beads, metal power, or any other inorganic powder, pigments, colorants, fillers, antioxidants, ultraviolet ray absorbing agents, and silane coupling agents, without departing from the objects of the invention. The aqueous dispersion type pressure-sensitive adhesive may also contain fine particles to form a light-diffusing pressure-sensitive adhesive layer. When the pressure-sensitive adhesive coating liquid is an aqueous dispersion, these additives may also be added in the form of dispersion.

In an embodiment of the invention, the pressure-sensitive adhesive layer of the pressure-sensitive adhesive optical film is formed using the pressure-sensitive adhesive coating liquid. The pressure-sensitive adhesive coating liquid generally has a solids content of about 1 to about 70% by weight. The pressure-sensitive adhesive coating liquid to be applied has a dissolved oxygen concentration controlled to 0.02 to 3 mg/L as stated above. The dissolved oxygen concentration can be controlled by performing the step (1) of degassing the pressure-sensitive adhesive coating liquid. When the degassing step (1) is performed, the pressure in a tank of a degassing apparatus may be reduced to about 10 kPa or less, preferably 5 kPa or less, more preferably 2 kPa or less.

Subsequently, the degassing step (1) is followed sequentially by the step (2) of applying, to one or both sides of a base substrate, the pressure-sensitive adhesive coating liquid having undergone the degassing and by the step (3) of drying the applied pressure-sensitive adhesive coating liquid to form a pressure-sensitive adhesive layer.

In the method for manufacturing the pressure-sensitive adhesive optical film, the dissolved oxygen concentration of the pressure-sensitive adhesive coating liquid after the degassing step (1) is preferably 10% or less of that before the degassing step (1).

In the degassing step (1), the dissolved oxygen concentration of the pressure-sensitive adhesive coating liquid may be controlled to 15% or less of that before the degassing, so that air bubbles produced in the pressure-sensitive adhesive layer can be significantly reduced. The dissolved oxygen concentration is preferably 10% or less, more preferably 8% or less, even more preferably 5% or less of that before the treatment.

In a preferred mode of the method for manufacturing the pressure-sensitive adhesive optical film, the degassing step (1) is performed in a tank of a degassing apparatus, the pressure-sensitive adhesive coating liquid is supplied to the applying step (2) using a pump set tank that is connected to the tank of the degassing apparatus through a connecting pipe, and the pressure-sensitive adhesive coating liquid having undergone the degassing step (1) is fed from the tank of the degassing apparatus to the pump set tank, while pressures are each set in such a manner that the pressure in the pump set tank and the pressure in the connecting pipe are each 1 kPa to 50 kPa lower than the pressure in the tank of the degassing apparatus.

In another preferred mode of the method for manufacturing the pressure-sensitive adhesive optical film, the degassing step (1) is performed in a tank of a degassing apparatus, the pressure-sensitive adhesive coating liquid is supplied to the applying step (2) using a pump set tank that is connected to the tank of the degassing apparatus through a buffer tank and a connecting pipe, the pressure-sensitive adhesive coating liquid having undergone the degassing step (1) is fed from the tank of the degassing apparatus to the buffer tank, while pressures are each set in such a manner that the pressure in the buffer tank and the pressure in the connecting pipe are each 1 kPa to 50 kPa lower than the pressure in the tank of the degassing apparatus, and the pressure-sensitive adhesive coating liquid is fed from the buffer tank to the pump set tank, while pressures are each set in such a manner that the pressure in the pump set tank and the pressure in the connecting pipe are each 1 kPa to 50 kPa lower than the pressure in the buffer tank.

In the manufacturing method, after the degassing step (1) is performed on the pressure-sensitive adhesive coating liquid, the applying step (2) and then the pressure-sensitive adhesive layer forming step (3) are performed. In the degassing step (1), air bubbles are removed from the pressure-sensitive adhesive coating liquid so that it can have a predetermined dissolved oxygen concentration, and the degassed pressure-sensitive adhesive coating liquid is fed from the degassing apparatus to the pump set tank under reduced pressure with the aid of a pressure difference produced by pressure reducing means. Therefore, the degassing apparatus, the connecting pipe, and the pump set tank are under reduced pressure, and in the process of feeding the pressure-sensitive adhesive coating liquid from the degassing apparatus to the pump set tank through the connecting pipe, air is reliably prevented from being mixed in the form of bubbles into or being dissolved in the pressure-sensitive adhesive coating liquid even when air remains in the system. In addition, even when air bubbles are mixed again into the pressure-sensitive adhesive coating liquid, they can be easily guided to the gas-liquid interface and easily destroyed. Since the pressure-sensitive adhesive coating liquid is fed with the aid of a pressure difference, the feed rate of the pressure-sensitive adhesive coating liquid can be easily controlled. In addition, no pump is necessary for feeding the liquid, so that the properties of the pressure-sensitive adhesive coating liquid can be prevented from being changed by the effect of the shear or heat of a pump. The pressure difference between the respective tanks is preferably in the range of 1 kPa to 50 kPa, more preferably in the range of 5 kPa to 20 kPa. In the initial state (where no aqueous dispersion type pressure-sensitive adhesive is fed), the pressure difference between the tanks may exceed the above range.

In the process of forming the pressure-sensitive adhesive layer, the pressure-sensitive adhesive coating liquid degassed in the degassing step (1) is fed from the degassing apparatus to the pump set tank under reduced pressure with the aid of a pressure difference produced by pressure reducing means, so that the dissolved oxygen concentration of the pressure-sensitive adhesive coating liquid can be easily maintained in a predetermined range in the applying step (2).

Conventionally, there have been proposed various methods and apparatuses for feeding a pressure-sensitive adhesive coating liquid while the pressure-sensitive adhesive coating liquid is degassed or defoamed. For example, JP-A No. 2004-249215 discloses a degassing system that is configured to detect, by dissolved oxygen concentration detecting means, the dissolved oxygen concentration of at least one of a coating liquid being fed to a degassing apparatus before degassing and a coating liquid discharged from the degassing apparatus after degassing and to control the degree of degassing in the degassing apparatus by control means for controlling degassing control means based on the result of the detection by the dissolved oxygen concentration detecting means. JP-A No. 2000-262956 discloses a liquid feeding method including reducing the pressure in a liquid feeding system for feeding a coating liquid to a coating head when the feeding of the coating liquid to the coating head is started, then filling the liquid feeding system with a sealing liquid, and then pushing and replacing the sealing liquid by the coating liquid.

In the degassing system or the liquid feeding method disclosed in the patent document, the coating liquid is continuously degassed in line with a degassing apparatus. However, such a technique is applicable only to cases where the coating liquid generally has a low viscosity of less than 100 mPa·s. When the coating liquid has a high viscosity of 100 mPa·s or more, especially, 1,000 mPa·s or more, it is difficult to continuously degassing the coating liquid in line with a degassing apparatus. In such a case, degassing or defoaming is generally performed by a batch method.

When a coating liquid with a high viscosity is degassed or defoamed by a batch method as mentioned above, a large amount of a high-viscosity coating liquid can be degassed or defoamed at a time. However, the degassed or defoamed coating liquid is not used at a time. In such a case, the coating liquid degassed or defoamed as mentioned above is temporarily stored in a storage tank such as a buffer tank, and such a stored coating liquid is fed to a pump set tank or the like by a pump immediately before it is applied, and then it is supplied to a coating head. When a high-viscosity coating liquid is degassed or defoamed by a batch method as mentioned above, it is usually transferred through a plurality of tanks until it is supplied to the coating head. In addition, since a pump is used to feed the coating liquid, there is a high risk of dissolving air bubbles in the coating liquid.

If air bubbles are dissolved in the coating liquid, air bubbles may remain in a pressure-sensitive adhesive layer formed by the application with the coating head, so that the appearance of the pressure-sensitive adhesive layer may be degraded or the thickness of the pressure-sensitive adhesive layer may vary. After drying, air bubbles may also remain in the pressure-sensitive adhesive layer. To solve this problem, it is necessary to remove the dissolved air again from the coating liquid and to strictly manage the degassed or defoamed coating liquid. In such a case, excessive degassing or defoaming should be performed, so that significant losses can be produced in the process.

According to the invention, even when degassing or defoaming is performed by a batch method, air bubbles can be reliably prevented from being mixed into or dissolved in the pressure-sensitive adhesive coating liquid in the process of feeding the pressure-sensitive adhesive coating liquid, so that the pressure-sensitive adhesive layer can be successfully formed.

In the steps (1) to (3), which may be performed in series, the degassing step (1) is performed in a tank of a degassing apparatus, the pressure-sensitive adhesive coating is supplied to the applying step (2) using a pump set tank that is connected to the tank of the degassing apparatus through a connecting pipe, and the pressure-sensitive adhesive coating having undergone the degassing step (1) is preferably fed from the degassing apparatus to the pump set tank with the aid of the difference between the pressures in the respective tanks. The tank of the degassing apparatus may be connected to the pump set tank through a buffer tank and a connecting pipe. Also in this case, the pressure-sensitive adhesive coating is preferably fed from the degassing apparatus to the pump set tank with the aid of the difference between the pressures in the respective tanks.

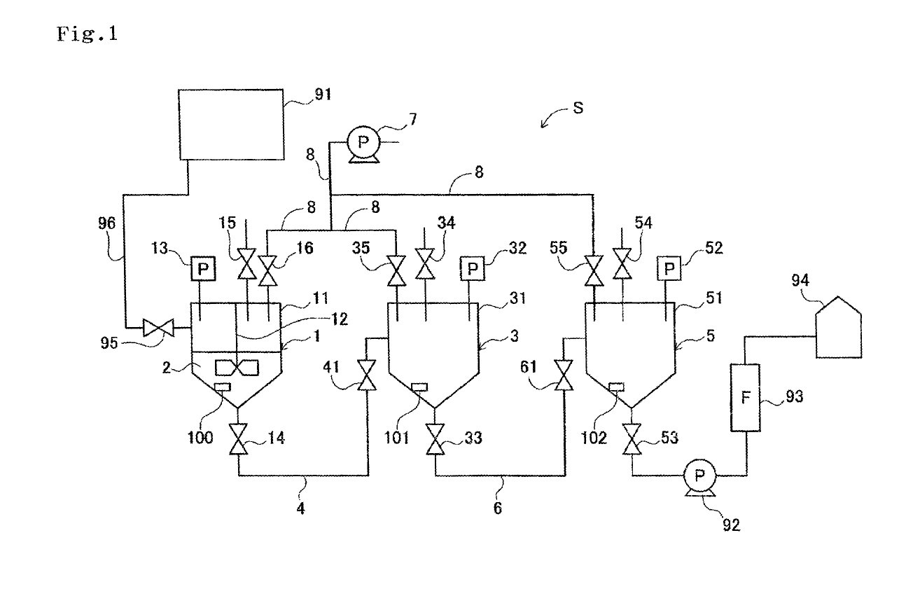

Hereinafter, the step (1) of degassing the pressure-sensitive adhesive coating and the reduced pressure process of the feeding from the degassing step (1) to the applying step (2) are described with reference to the drawings. FIG. 1 is a schematic diagram showing a system according to an embodiment of the invention for applying the pressure-sensitive adhesive coating. In this case, a tank of a degassing apparatus is connected to a pump set tank through a buffer tank and a connecting pipe. While FIG. 1 shows a case where a single buffer tank is provided, two or more buffer tanks may be provided alternatively. When two or more buffer tanks are provided, buffer tanks are connected to one another through a connecting pipe or pipes interposed therebetween, and the pressures are each set so that the pressure in the buffer tank for receiving the pressure-sensitive adhesive coating and the pressure in the connecting pipe are each 1 kPa to 50 kPa lower than the pressure in the buffer tank for feeding the pressure-sensitive adhesive coating, in which the pressure-sensitive adhesive coating is fed with the aid of the difference between the pressures in the respective buffer tanks as stated above. Such an applying system in which the feeding is performed under reduced pressure is preferable when the pressure-sensitive adhesive coating liquid is an aqueous dispersion type pressure-sensitive adhesive.

In FIG. 1, a pressure-sensitive adhesive applying system S basically includes a degassing apparatus 1 for degassing an pressure-sensitive adhesive coating 2 which is placed in a batch type closed tank 11 and contains a pressure-sensitive adhesive; a buffer tank 3 including a closed tank 31 for temporarily storing the pressure-sensitive adhesive coating 2 having undergone degassing in the close tank 11; a pump set tank 5 including a closed tank 51 for storing the pressure-sensitive adhesive coating 2 fed from the closed tank 31 of the buffer tank 3 before it is applied; a feed pump 92 for feeding the pressure-sensitive adhesive coating 2 from the closed tank 51 of the pump set tank 5 to a coating apparatus 94 through a filter 93; and a vacuum pump 7 for reducing the pressure in the closed tank 11 of the degassing apparatus 1, the pressure in the closed tank 31 of the buffer tank 3, the pressure in the closed tank 51 of the pump set tank 5, and so on.

In this system, the closed tank 11 of the degassing apparatus 1 is connected to the closed tank 31 of the buffer tank 3 through a connecting pipe 4, and the connecting pipe 4 has a drain valve 14 at a closed tank 11-side intermediate portion and also has an opening/closing valve 41 at an intermediate portion on the side of the closed tank 31 of the buffer tank 3. The closed tank 31 of the buffer tank 3 is connected to the closed tank 51 of pump set tank 5 through a connecting pipe 6, and the connecting pipe 6 has a drain valve 33 at an intermediate portion on the side of the closed tank 31 of the buffer tank 3 and also has an opening/closing valve 61 at an intermediate portion on the side of the closed tank 51 of the pump set tank 5. A drain valve 53 is also inserted downstream of the pump set tank 5 and connected to a pump 92.

The closed tank 11 of the degassing apparatus 1 is also connected to the vacuum pump 7 through a suction pipe 8 with a vacuum valve 16 interposed therebetween, and the closed tank 31 of the buffer tank 3 is also connected to the vacuum pump 7 through a suction pipe 8 with a vacuum valve 35 interposed therebetween. The closed tank 51 of the pump set tank 5 is also connected to the vacuum pump 7 through a suction pipe 8 with a vacuum valve 55 interposed therebetween.

The degassing apparatus 1 has the closed tank 11, and a stirring blade 12 for stirring the pressure-sensitive adhesive coating 2 is placed in the closed tank 11. A pressure gauge 13, a leak valve 15, and the vacuum valve 16 inserted in the suction pipe 8 are attached to the upper part of the closed tank 11. The pressure in the closed tank 11 of the degassing apparatus 1 is controlled by controlling the opening of the leak valve 15 and the vacuum valve 16 in the operation. The closed tank 11 of the degassing apparatus 1 is also connected to a charge tank 91 through a connecting pipe 96, in which the charge tank 91 is used to supply the pressure-sensitive adhesive coating 2 to the closed tank 11. The amount of the pressure-sensitive adhesive coating 2 being supplied from the charge tank 91 to the closed tank 11 is controlled by controlling the opening/closing of the opening/closing valve 95.

The buffer tank 3 has the closed tank 31, and a pressure gauge 32, a leak valve 34, and the vacuum valve 35 inserted in the suction pipe 8 are attached to the upper part of the closed tank 31. The pressure in the closed tank 31 is controlled by controlling the opening of the leak valve 34 and the vacuum valve 35 in the operation.

The pump set tank 5 has the closed tank 51, and a pressure gauge 52, a leak valve 54, and the vacuum valve 55 inserted in the suction pipe 8 are attached to the upper part of the closed tank 51. The pressure in the closed tank 51 is controlled by controlling the opening of the leak valve 54 and the vacuum valve 55 in the operation.

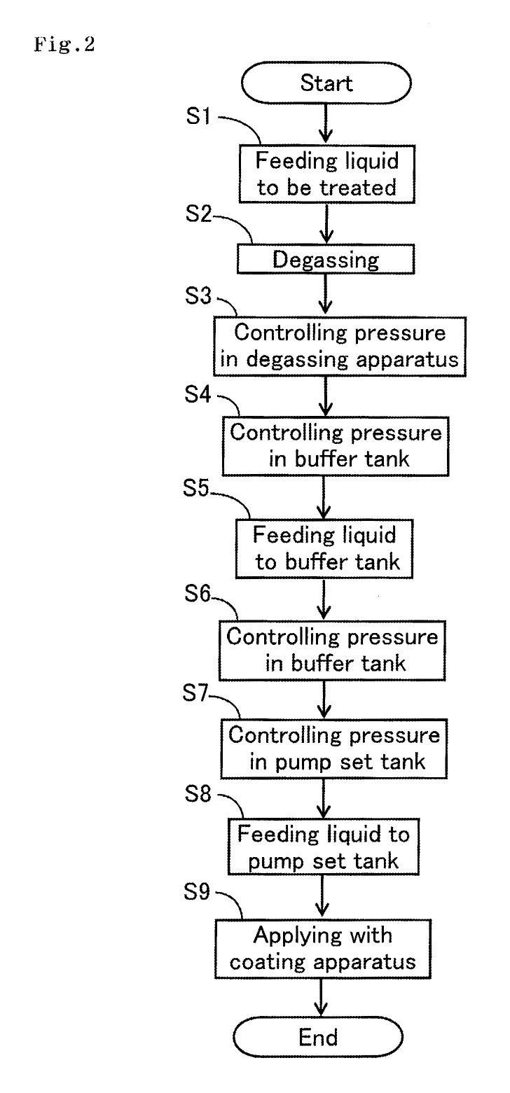

Next, the treatment operation performed in the pressure-sensitive adhesive applying system S configured as described above is described with reference to FIG. 2. FIG. 2 is a flow chart showing the treatment operation performed in the pressure-sensitive adhesive applying system.

First, the pressure-sensitive adhesive coating 2 is fed from the charge tank 91 into the closed tank 11 for degassing operation 1 by opening the opening/closing valve 95 (S1). Subsequently, the step (1) of degassing the pressure-sensitive adhesive coating 2 is performed in the degassing apparatus 1 (S2). During the degassing, the vacuum valve 16 is opened, and other valves including the leak valve 15, the opening/closing valve 95, and the drain valve 14 are closed. The pressure in the closed tank 11 is reduced by the vacuum pump 7, and the stirring blade 12 is rotated. Thus, the pressure-sensitive adhesive coating 2 is degassed. The degassing step (1) may be performed while the pressure in the closed tank 11 for the degassing operation 1 is reduced to about 10 kPa or less, preferably 5 kPa or less, more preferably 2 kPa or less.

After the degassing is completed, the rotation of the stirring blade 12 is stopped, and the opening of the leak valve 15 is controlled so that the pressure in the closed tank 11 is controlled to a predetermined set value (S3). Thereafter, all the valves are closed so that a hermetically sealed system is maintained in the degassing apparatus 1.

Subsequently, the vacuum valve 35 and the opening/closing valve 41 attached to the closed tank 31 of the buffer tank 3 are opened, and the pressures in the closed tank 31 and the connecting pipe 4 are reduced by the vacuum pump 7. In this process, the degree of reduction in pressure is an important factor for regulating the amount of residual air in the liquid supply system so that contamination of the pressure-sensitive adhesive coating 2 with air bubbles can be prevented. In an embodiment of the invention, the absolute pressure in the reduced-pressure feed system should be 50 kPa or less, preferably 20 kPa or less, more preferably 7 kPa or less. If air is present in a liquid supply path, a gas-liquid interface will be formed at that plate, so that the risk of incorporating air bubbles into the pressure-sensitive adhesive coating 2 will be increased by the transfer of the pressure-sensitive adhesive coating 2. Therefore, it is necessary to reduce the pressure in the liquid supply system as described above. In addition, since the saturated vapor pressure varies with the nature of the pressure-sensitive adhesive coating 2, the pressure in the liquid supply system should also be set depending on the temperature during the liquid supply so that the pressure-sensitive adhesive coating 2 can be prevented from boiling.

The opening of the leak valve 34 is controlled by the operation so that the pressures in the closed tank 31 and the connecting pipe 4 are controlled to predetermined set values (S4). In this controlled state, the drain valve 14, which is inserted in the connecting pipe 4 and placed downstream of the closed tank 11, is opened. At this time, a pressure difference is produced between the closed tank 11 of the degassing apparatus 1 and the closed tank 31 of the buffer tank 3 and the connecting pipe 4, and based on the pressure difference, the feeding of the pressure-sensitive adhesive coating 2 from the closed tank 11 to the closed tank 31 is started (S5). When the pressure-sensitive adhesive coating 2 is fed based on the pressure difference as described above, the pressure difference between the upstream and downstream parts of the liquid supply is an important factor for controlling the liquid flow rate. In an embodiment of the invention, for example, the pressure difference is preferably in the range of 1 kPa to 50 kPa, more preferably in the range of 5 kPa to 20 kPa. If the pressure difference is too large, the liquid flow rate will increase so that the gas-liquid interface can rapidly fluctuate to trap air bubbles easily. In this embodiment, if the pressure difference is more than 50 kPa, the pressure-sensitive adhesive coating 2 may be often contaminated with air bubbles, and if the pressure difference is less than 1 kPa, the liquid flow rate may be too low to be suitable for production.

During the feeding of the pressure-sensitive adhesive coating 2, the opening of the leak valve 15 on the degassing apparatus 1 side and the opening of the leak valve 34 on the buffer tank 3 side are controlled so that the pressure in the closed tank 11 of the degassing apparatus 1 and the pressure in the closed tank 31 of the buffer tank 3 are each controlled to a predetermined set value (S6). In this process, the drain valve 14 and the opening/closing valve 41 are closed before the pressure-sensitive adhesive coating 2 is completely discharged from the closed tank 11. This prevents contamination of the pressure-sensitive adhesive coating 2 with air bubbles, which would otherwise be caused by air flow generated when the discharge of the pressure-sensitive adhesive coating 2 is completed.

In this process, when the pressure-sensitive adhesive coating 2 is fed into and stored in the closed tank 31 of the buffer tank 3, the tank 31 may be an open or closed system. Even when a closed system is formed, the pressure in the closed tank 31 of the buffer tank 3 may be a reduced pressure or the atmospheric pressure. When the closed tank 31 is kept at a reduced pressure, stationary degassing can be facilitated.

Subsequently, the vacuum valve 55 and the opening/closing valve 61 of the closed tank 51 of the pump set tank 5 are opened so that the pressures in the closed tank 51 and the connecting pipe 6 are reduced by the vacuum pump 7. The opening of the leak valve 54 is also controlled by the operation so that the pressures in the closed tank 51 and the connecting pipe 6 are controlled to predetermined set values (S7). In this controlled state, the drain valve 33 inserted in the connecting pipe 6 and placed downstream of the closed tank 31 is opened. In this process, a pressure difference is produced between the closed tank 31 and the closed tank 51 and the connecting pipe 6, and based on the pressure difference, the feeding of the pressure-sensitive adhesive coating 2 from the closed tank 31 to the closed tank 51 is started (S8). In this case, the pressure difference between the upstream and downstream parts of the liquid supply is preferably in the range of 1 kPa to 50 kPa, more preferably in the range of 5 kPa to 20 kPa, as described above.

During the feeding of the pressure-sensitive adhesive coating 2, the opening of the leak valve 34 on the buffer tank 3 side and the opening of the leak valve 54 on the pump set tank 5 side are controlled so that the pressure in the closed tank 31 of the buffer tank 3 and the pressure in the closed tank 51 of the pump set tank 5 are each controlled to a predetermined set value. In this process, the drain valve 33 and the opening/closing valve 61 are closed before the pressure-sensitive adhesive coating 2 is completely discharged from the closed tank 31. This prevents contamination of the pressure-sensitive adhesive coating 2 with air bubbles, which would otherwise be caused by air flow generated when the discharge of the pressure-sensitive adhesive coating 2 is completed.

After the pressure-sensitive adhesive coating 2 is fed to the closed tank 51 of the pump set tank 5 as described above, the drain valve 53 is opened, and the feed pump 92 is driven. Therefore, the pressure-sensitive adhesive coating 2 is fed from the feed pump 92 to the coating apparatus 94 through the filter 93. The coating apparatus 94 performs the step (2) of applying the pressure-sensitive adhesive coating 2 to one or both sides of a base substrate and then the step (3) of drying the applied the pressure-sensitive adhesive coating 2 to form a pressure-sensitive adhesive layer (S9). The feeding of the aqueous dispersion type pressure-sensitive adhesive 2 to the coating apparatus 94 is preferably performed after a process that includes first allowing water to flow through the filter 93 to remove air bubbles from the filter 93 and circulating the aqueous dispersion type pressure-sensitive adhesive 2 through the closed tank 51 for about 1 to 3 hours to replace water in the filter 93 with the aqueous dispersion type pressure-sensitive adhesive 2. Although not illustrated in FIG. 1, the circulation of the aqueous dispersion type pressure-sensitive adhesive 2 can be achieved using a system that includes: a valve provided in the liquid supply pipe connecting the filter 93 to the coating apparatus 94; and a circulation pipe branched from the liquid supply pipe and connected to the closed tank 51, in which the valve is opened and closed for circulation, or using a system that includes a detachable liquid supply pipe directly connected to the closed tank 51.

It will be understood that the operation of the vacuum pump 7 and different valves in the system may be manually performed while the indications of the pressure gauges 13, 32, and 52 are each checked, or automatically performed by remote control based on the indication of each of the pressure gauges 13, 32, and 52. The vacuum pump 7 may be a single pump or a set of plural pumps.

Next, a description is given of the measurement of the concentration of dissolved oxygen in the pressure-sensitive adhesive coating 2 from the time before the pressure-sensitive adhesive coating 2 is degassed to the time when the adhesive 2 is applied. Attention should be paid on the concentration of dissolved oxygen in the pressure-sensitive adhesive coating 2, because if air is dissolved in the pressure-sensitive adhesive coating 2, the air may form air bubbles during the drying of the pressure-sensitive adhesive coating 2 so that various problems may occur due to the air bubbles, and therefore, the concentration of dissolved oxygen in the pressure-sensitive adhesive coating 2 should be strictly controlled during the period from the degassing to the application. When the amount of dissolved air in the pressure-sensitive adhesive coating 2 is determined, the concentration of dissolved oxygen is generally used to indicate the amount of dissolved air in the pressure-sensitive adhesive coating 2.

The concentration of dissolved oxygen in the pressure-sensitive adhesive coating 2 is measured before the degassing step (1) is performed in the degassing apparatus 1 (before degassing), after the degassing is performed (after degassing), and after the feeding to the closed tank 31 of the buffer tank 3 (after feeding). The concentration of dissolved oxygen in the pressure-sensitive adhesive coating 2 to be applied is also measured before the applying step (2). In an embodiment of the invention, the concentration of dissolved oxygen in the pressure-sensitive adhesive coating 2 is specifically measured as described in Examples.

As shown in FIG. 1, a dissolved oxygen meter 100 is placed at the bottom of the closed tank 11 of the degassing apparatus 1. Using the dissolved oxygen meter 100, the concentration of dissolved oxygen in the pressure-sensitive adhesive coating 2 can be measured before the pressure-sensitive adhesive coating 2 placed in the closed tank 11 is degassed and after the pressure-sensitive adhesive coating 2 is degassed. Alternatively, a sample of the aqueous dispersion type pressure-sensitive adhesive 2 may be taken out of the system before and after the degassing, and the concentration of dissolved oxygen in each sample may be measured using a meter.

As shown in FIG. 1, a dissolved oxygen meter 101 is also placed at the bottom of the closed tank 31 of the buffer tank 3. Using the dissolved oxygen meter 101, the concentration of dissolved oxygen in the pressure-sensitive adhesive coating 2 can be measured after the pressure-sensitive adhesive coating 2 is fed to the buffer tank 3. As mentioned above, a sample of the aqueous dispersion type pressure-sensitive adhesive 2 may also be taken out of the system, and the concentration of dissolved oxygen in the sample may be measured using a meter.

As shown in FIG. 1, a dissolved oxygen meter 102 is further placed at the bottom of the closed tank 51 of the pump set tank 5. Using the dissolved oxygen meter 102, the concentration of dissolved oxygen in the pressure-sensitive adhesive coating 2 before the applying step (2) can be measured before and after it is circulated through the filter. In addition, two or more samples of the pressure-sensitive adhesive coating may be extracted before the applying step (2) and each subjected to the measurement of the concentration of dissolved oxygen, and the final concentration of dissolved oxygen in the pressure-sensitive adhesive coating may be measured after the applying step (2). In FIG. 1, the dissolved oxygen concentration of the pressure-sensitive adhesive coating liquid 2 before the applying step (2) is the measured value of a sample of the pressure-sensitive adhesive coating liquid 2 taken out upstream of the coating apparatus 94 (at a portion immediately upstream of the coater). The dissolved oxygen concentration of the pressure-sensitive adhesive coating liquid 2 after the applying step (2) is the measured vale of a sample of the pressure-sensitive adhesive coating liquid 2 remaining upstream of the coating apparatus 94 (at a portion immediately upstream of the coater) at the time of completion of the application.

Next, a description is given of the applying step (2) and the pressure-sensitive adhesive layer forming step (3). By these steps, a pressure-sensitive adhesive optical film is obtained, which includes an optical film and a pressure-sensitive adhesive layer formed thereon. The base substrate to be used may be any of various materials, examples of which include an optical film, a surface protecting film substrate, and a separator.

When the base substrate is a separator, for example, the pressure-sensitive adhesive coating liquid is applied to the separator and dried to form a pressure-sensitive adhesive layer. The pressure-sensitive adhesive layer formed may be transferred from the separator to an optical film so that a pressure-sensitive adhesive optical film can be obtained. When an optical film is used as the base substrate, the pressure-sensitive adhesive coating liquid may be directly applied to the optical film and then dried to form a pressure-sensitive adhesive layer on the optical film, so that a pressure-sensitive adhesive optical film can be obtained.

The applying step (2) may be performed using any of various methods. Examples include roll coating, kiss roll coating, gravure coating, reverse coating, roll brushing, spray coating, dip roll coating, bar coating, knife coating, air knife coating, curtain coating, lip coating, and extrusion coating with a die coater or the like.

In the pressure-sensitive adhesive layer forming step (3), normal conditions may be used depending on the pressure-sensitive adhesive coating liquid. For example, in the case of the aqueous dispersion type pressure-sensitive adhesive, a drying temperature of, for example, 40 to 150° C. and a drying time of 20 seconds to 30 minutes may be used. In the case of the organic solvent type pressure-sensitive adhesive, a drying temperature of, for example, 40 to 200° C. and a drying time of 20 seconds to 30 minutes may be used. When the pressure-sensitive adhesive used is radiation-curable, a radiation such as an electron beam (at an acceleration voltage of 5 to 300 kV) or ultraviolet light (for example, 100 to 500 mJ/m2) is applied simultaneously with or after the drying step.

The thickness of the pressure-sensitive adhesive layer is typically, but not limited to, from about 1 to about 100 μm, preferably from 5 to 50 μm, more preferably from 10 to 30 μm.

Examples of the material used to form the separator include a plastic film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A plastic film is preferably used, because of its good surface smoothness.

Any plastic film capable of protecting the pressure-sensitive adhesive layer may be used, examples of which include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is generally from about 5 to about 200 μm, preferably from about 5 to about 100 μm. If necessary, the separator may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the separator is appropriately subjected to a release treatment such as a silicone treatment, a long-chain alkyl treatment, or a fluorine treatment, the releasability from the pressure-sensitive adhesive layer can be further increased.

The pressure-sensitive adhesive layer may be exposed. In such a case, the pressure-sensitive adhesive layer may be protected by the separator until it is actually used. The release-treated sheet used in the preparation of the pressure-sensitive adhesive member may be used as is as a separator for a pressure-sensitive adhesive optical film, so that the process can be simplified.

When the base substrate is a surface protecting film substrate or an optical film may also be coated with an anchor layer or subjected to any adhesion-facilitating treatment such as a corona treatment or a plasma treatment so as to have improved adhesion to a pressure-sensitive adhesive layer, and then the pressure-sensitive adhesive layer may be formed. The surface of the pressure-sensitive adhesive layer may also be subjected to an adhesion-facilitating treatment.

Materials that may be used to form the anchor layer preferably include an anchoring agent selected from polyurethane, polyester, and polymers containing an amino group in the molecule, in particular, preferably polymers containing an amino group in the molecule. Polymers containing an amino group in the molecule allow the amino group in the molecule to react with a carboxyl group or the like in the pressure-sensitive adhesive or to make an interaction such as an ionic interaction, so that good adhesion can be ensured.

Examples of polymers containing an amino group in the molecule include polyethyleneimine, polyallylamine, polyvinylamine, polyvinylpyridine, polyvinylpyrrolidine, and a polymer of an amino group-containing monomer such as dimethylaminoethyl acrylate.

The optical film is, but not limited to the kinds, used for forming image display such as liquid crystal display. A polarizing plate is exemplified. A polarizing plate including a polarizer and a transparent protective film provided on one side or both sides of the polarizer is generally used.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally about 5 to about 80 μm.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

An optical film of the invention may be exemplified as other optical layers, such as a reflective plate, a transflective plate, a retardation plate (a half wavelength plate and a quarter wavelength plate included), and a viewing angle compensation film, which may be used for formation of a liquid crystal display etc. These are used in practice as an optical film, or as one layer or two layers or more of optical layers laminated with polarizing plate.

Although an optical film with the above described optical layer laminated to the polarizing plate may be formed by a method in which laminating is separately carried out sequentially in manufacturing process of a liquid crystal display or the like, an optical film in a form of being laminated beforehand has an outstanding advantage that it has excellent stability in quality and assembly workability, and thus manufacturing processes ability of a liquid crystal display or the like may be raised. Proper adhesion means, such as a pressure-sensitive adhesive layer, may be used for laminating. On the occasion of adhesion of the above described polarizing plate and other optical films, the optical axis may be set as a suitable configuration angle according to the target retardation characteristics or the like.

The pressure-sensitive adhesive optical film of the invention is preferably used to form various types of image displays such as liquid crystal displays. Liquid crystal displays may be produced according to conventional techniques. Specifically, liquid crystal displays are generally produced by appropriately assembling a display panel such as a liquid crystal cell and the pressure-sensitive adhesive optical film and optionally other components such as a lighting system and incorporating a driving circuit according to any conventional technique, except that the pressure-sensitive adhesive optical film of the invention is used. Any type of liquid crystal cell may also be used such as a TN type, an STN type, a a type, a VA type and an IPS type.

Suitable liquid crystal displays, such as liquid crystal display with which the above pressure-sensitive adhesive optical film has been provided on one side or both sides of the display panel such as a liquid crystal cell, and with which a backlight or a reflective plate is used for a lighting system may be manufactured. In this case, the pressure-sensitive adhesive optical film may be provided on one side or both sides of the display panel such as a liquid crystal cell. When providing the pressure-sensitive adhesive optical films on both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

### EXAMPLES

Hereinafter, the invention is more specifically described with reference to the Examples, which however are not intended to limit the invention. Unless otherwise stated, “parts” and “%” in each example are all by weight.

### Example 1

### Preparation of Aqueous Dispersion Type Pressure-Sensitive Adhesive

To a reaction vessel equipped with a condenser tube, a nitrogen introducing tube, a thermometer, and a stirrer were added 30 parts of water and 0.3 parts of ammonium persulfate, and the air was replaced with nitrogen under stirring for 1 hour. The resulting aqueous solution had a dissolved oxygen concentration of 0.2 mg/L. An emulsion was obtained by emulsifying 95 parts of butyl acrylate, 5 parts of acrylic acid, and 1.0 part (solid basis) of ammonium polyoxyethylene lauryl ether sulfate (HITENOL LA-16 (trade name) manufactured by DAI-ICHI KOGYO SEIYAKU CO., LTD.) as an emulsifying agent with 70 parts of water. The emulsion was added dropwise to the above solution at 80° C. over 3 hours, and the reaction product was further aged at 80° C. for 2 hours. Subsequently, the reaction product was cooled to room temperature and adjusted to pH 8 with 10% by weight ammonia water to give an acryl-based copolymer emulsion with a solid content of 39%. During the emulsion polymerization, the dissolved oxygen concentration was 0.2 mg/L at every step until the stage where the aging was completed. Subsequently, the reaction mixture was cooled and subjected to a neutralizing step without replacement with nitrogen gas. The resulting acryl-based copolymer emulsion had a dissolved oxygen concentration of 6.50 mg/L. Into the acryl-based copolymer emulsion was mixed 0.1 parts (solid basis) of an oxazoline group-containing water-soluble crosslinking agent (EPOCROS WS-700 (trade name) manufactured by NIPPON SHOKUBAI CO., LTD., 220 g·solid/eq. (oxazoline group equivalent)) based on 100 parts of the solid (acryl-based copolymer) of the acryl-based copolymer emulsion, so that an aqueous dispersion type acryl-based pressure-sensitive adhesive (with a solids content of 39% (including the crosslinking agent) and a viscosity of 6,000 mPa·s) was obtained.

### (Degassing of the Aqueous Dispersion Type Pressure-Sensitive Adhesive)

According to FIG. 1, operation was performed as described below. First, the aqueous dispersion type pressure-sensitive adhesive 2 (80 kg) was fed into the closed tank 11 of the degassing apparatus 1. In this state, the aqueous dispersion type pressure-sensitive adhesive 2 was sampled and measured for dissolved oxygen concentration using the dissolved oxygen concentration meter 100 before degassing. As a result, the dissolved oxygen concentration was 7.25 mg/L.

The aqueous dispersion type pressure-sensitive adhesive 2 placed in the closed tank 11 was degassed for 30 minutes. During the degassing, the vacuum valve 16 was opened, and the other valves connected to the degassing apparatus 1 were all closed. The internal pressure of the closed tank 11 was set at 10 kPa and the stirring blade 12 was rotated, when the degassing was performed under reduced pressure. Thereafter, the aqueous dispersion type pressure-sensitive adhesive 2 was fed from the closed tank 11 of the degassing apparatus to the closed tank 31 of the buffer tank 3 and then to the closed tank 51 of the pump set tank 5. In each feeding step, the aqueous dispersion type pressure-sensitive adhesive 2 was fed with the aid of the pressure difference between the respective tanks. The aqueous dispersion type pressure-sensitive adhesive 2 was also fed from the closed tank 51 to the coating apparatus 94 by the feed pump 92, when the pressure-sensitive adhesive layer was formed.

The dissolved oxygen concentration was measured by a process including placing the sample (about 150 ml) of the aqueous dispersion type pressure-sensitive adhesive in a 200 ml wide-mouthed glass bottle, placing therein the electrode of the dissolved oxygen concentration meter (Dissolved Oxygen Meter/model, Thermo Electron Co.), and measuring the dissolved oxygen concentration under gentle stirring. The measurement was performed at a temperature of 26° C. The dissolved oxygen concentrations of other samples were also measured in the same manner.

### (Formation of Pressure-Sensitive Adhesive Layer and Preparation of Pressure-Sensitive Adhesive Polarizing Plate)

The aqueous dispersion type pressure-sensitive adhesive 2 fed as described above was applied to the surface of a separator, which was made of a release-treated polyethylene terephthalate film (38 μm in thickness), using a die coater in such a manner that the coating could have a thickness of 20 μm after drying, and subsequently, the coating was dried at 120° C. for 5 minutes to form a pressure-sensitive adhesive layer. The pressure-sensitive adhesive layer was transferred to a polarizing plate (3G-DU manufactured by NITTO DENKO CORPORATION) to form a pressure-sensitive adhesive polarizing plate. The aqueous dispersion type pressure-sensitive adhesive 2 being applied had a dissolved oxygen concentration of 2.98 mg/L. Immediately before the application, the aqueous dispersion type pressure-sensitive adhesive 2 was sampled upstream of the coating apparatus 94 (at a portion immediately upstream of the coater) and measured for dissolved oxygen concentration.

### Examples 2 to 6 and Comparative Examples 1 to 4

Pressure-sensitive adhesive polarizing plates were obtained as in Example 1, except that the conditions for degassing the aqueous dispersion type pressure-sensitive adhesive were changed as shown in Table 1.

### Example 7

### Preparation of Organic Solvent Type Pressure-Sensitive Adhesive

To a reaction vessel equipped with a condenser tube, a nitrogen introducing tube, a thermometer, and a stirrer were added 100 parts of butyl acrylate, 5 parts of acrylic acid, 0.075 parts of 2-hydroxyethyl acrylate, 0.3 parts of 2,2′-azobisisobutyronitrile, and ethyl acetate to form a solution. While nitrogen gas was blown into the solution, the solution was then allowed to react at 60° C. for 4 hours under stirring to give a solution containing an acryl-based polymer with a weight average molecular weight of 2,200,000. Ethyl acetate was then added to the (meth)acryl-based polymer-containing solution so that an acryl-based polymer solution (A) with an adjusted solids content of 30% was obtained.

Based on 100 parts of the solids of the acryl-based polymer solution (A), 0.6 parts of a crosslinking agent composed mainly of an isocyanate group-containing compound (Coronate L (trade name) manufactured by Nippon Polyurethane Industry Co., Ltd.) and 0.075 parts of γ-glycidoxypropyltrimethoxysilane (KMB-403 (trade name) manufactured by Shin-Etsu Chemical Co., Ltd.) as a silane coupling agent were added in this order to the acryl-based polymer solution so that an organic solvent type pressure-sensitive adhesive solution was prepared.

### (Degassing of the Organic Solvent Type Pressure-Sensitive Adhesive and Formation of Pressure-Sensitive Adhesive Layer)

A pressure-sensitive adhesive layer was formed as in Example 1 after degassing and feeding were performed as in Example 1, except that the organic solvent type pressure-sensitive adhesive prepared as described above was used in place of the aqueous dispersion type pressure-sensitive adhesive. A pressure-sensitive adhesive polarizing plate was also obtained by transferring the pressure-sensitive adhesive layer to a polarizing plate (3G-DU manufactured by NITTO DENKO CORPORATION) as in Example 1.

### Examples 8 to 11 and Comparative Examples 5 and 6

Pressure-sensitive adhesive polarizing plates were obtained as in Example 7, except that the conditions for degassing the organic solvent type pressure-sensitive adhesive were changed as shown in Table 2.

### Example 12

### Preparation of Radiation-Curable, Organic Solvent-Type, Pressure-Sensitive Adhesive

Based on 100 parts of the solids of the acryl-based polymer solution (A) prepared by the same method as in Example 7, 4.5 parts of glycidyl methacrylate and 0.3 parts of dibutyltin laurate as a catalyst were added to the acryl-based polymer solution (A), and the mixture was allowed to react under atmospheric pressure at room temperature for 24 hours, so that a radiation-curable base polymer was obtained by introducing a methacryloyl group into the acryl-based polymer (A). Based on 100 parts of the solids of the radiation-curable base polymer, 0.4 parts of a photopolymerization initiator (1-hydroxycyclohexyl phenyl ketone) was added to the radiation-curable base polymer to form a radiation-curable, organic solvent-type, pressure-sensitive adhesive.

### (Degassing of the Radiation-Curable, Organic Solvent-Type, Pressure-Sensitive Adhesive and Formation of Pressure-Sensitive Adhesive Layer

The same procedure was performed as in Example 1 after degassing and feeding were performed as in Example 1, except that the radiation-curable, organic solvent-type, pressure-sensitive adhesive prepared as described above was used in place of the aqueous dispersion type pressure-sensitive adhesive. Ultraviolet light (a 120 W high-pressure mercury lamp, 10 cm in irradiation distance, 5 m/minute in line speed) was further applied from the separator side when a pressure-sensitive adhesive layer is formed. A pressure-sensitive adhesive polarizing plate was also obtained by transferring the pressure-sensitive adhesive layer to a polarizing plate (3G-DU manufactured by NITTO DENKO CORPORATION) as in Example 1.

### Examples 13 to 16 and Comparative Examples 7 and 8

Pressure-sensitive adhesive polarizing plates were obtained as in Example 12, except that the conditions for degassing the radiation-curable, organic solvent-type, pressure-sensitive adhesive were changed as shown in Table 3.

The pressure-sensitive adhesive polarizing plates obtained in the examples and the comparative examples were evaluated as described below. The results of the evaluation are shown in Tables 1 to 3.

### <Heat Durability>

The pressure-sensitive adhesive polarizing plate (15 inch size) was bonded to a non-alkali glass plate (Corning 1737, 0.7 mm in thickness) and autoclaved under 0.5 MPa at 50° C. for 15 minutes. The resulting sample was heat-treated at 80° C. for 500 hours. The degree of generation of air bubbles in the treated sample (the pressure-sensitive adhesive layer of the pressure-sensitive adhesive polarizing plate) was evaluated according to the criteria below by observing the number and size of the air bubbles with an optical microscope (In the evaluation, the air bubbles present before the treatment were omitted).

5: The number of air bubbles with a maximum length of 100 μm or more was zero per 1 cm².

4: The number of air bubbles with a maximum length of 100 μm or more was 5 or less per 1 cm².

3: The number of air bubbles with a maximum length of 100 μm or more was from 6 to 10 per 1 cm².

2: The number of air bubbles with a maximum length of 100 μm or more was from 11 to 100 per 1 cm².

1: The number of air bubbles with a maximum length of 100 μm or more was from 6 to 101 or more per 1 cm².

### <Humidity Durability>

The pressure-sensitive adhesive polarizing plate (15 inch size) was bonded to a non-alkali glass plate (Corning 1737, 0.7 mm in thickness) and autoclaved under 0.5 MPa at 50° C. for 15 minutes. Subsequently, the resulting sample was treated in an environment at 60° C. and 95% R.H. for 500 hours. The degree of peeling between the pressure-sensitive adhesive polarizing plate and the non-alkali glass plate in the treated sample was visually observed and evaluated according to the following criteria.

5: No peeling occurred.

4: Peeling occurred at a location within 0.1 mm from the end of the pressure-sensitive adhesive polarizing plate.

3: Peeling occurred at a location within 0.5 mm from the end of the pressure-sensitive adhesive polarizing plate.

2: Peeling occurred at a location within 1.0 mm from the end of the pressure-sensitive adhesive polarizing plate.

1: Peeling occurred at a location 1.0 mm or more apart from the end of the pressure-sensitive adhesive polarizing plate.

### <Contrast>

A liquid crystal panel was taken out of a commercial liquid crystal display (a 40 inch liquid crystal television, Bravia 46V1 (trade name) manufactured by SONY CORPORATION) including a VA-mode liquid crystal cell, and all optical films including polarizing plates placed on the upper and lower sides of the liquid crystal cell were removed. The liquid crystal cell, of which the front and rear glass plates were cleaned, was named liquid crystal cell A. The pressure-sensitive adhesive layer side of the pressure-sensitive adhesive polarizing plate obtained in each of the examples and the comparative examples was bonded to the viewer side of the liquid crystal cell A in such a manner that the direction of the absorption axis of the polarizing plate was substantially parallel to the direction of the long side of the liquid crystal cell A. Subsequently, the pressure-sensitive adhesive layer side of the same pressure-sensitive adhesive polarizing plate obtained in each of the examples and the comparative examples was also bonded to the opposite side (backlight side) of the liquid crystal cell A from the viewer side in such a manner that the direction of the absorption axis of the polarizing plate was substantially perpendicular to the direction of the long side of the liquid crystal cell A. The product was named liquid crystal panel A. The directions of the absorption axes of the polarizing plates on the viewer and backlight sides of the liquid crystal panel A were substantially perpendicular to each other. The liquid crystal panel A was combined with the original liquid crystal display backlight unit to form a liquid crystal display A.

### <Measurement of Contrast>

Method for measuring the contrast ratio in the normal direction of the liquid crystal display A: Thirty minutes after the backlight was turned on in a darkroom at 23° C., the Y value in the XYZ color system was measured using BM-5 (product name) manufactured by TOPCON CORPORATION, whose lens was placed 50 cm apart from the panel screen, when a white image was displayed and when a black image was displayed. The Y value of the white image (YW: white luminance) and the Y value of the black image (YB: black luminance) were used to calculate the contrast ratio (YW/YB) in the normal direction.

The contrast is preferably 2,600 or more, more preferably 2,700 or more, 2,800 or more, 2,900 or more, or 3,000 or more.

TABLE 1

| | | Pressure-sensitive | | | |
|---|---|---|---|---|---|
| | | adhesive coating liquid | | | |
| | Degassing | Dissolved oxygen | | | |
| | Reduced | concentration (mg/L) of | Evaluation | | |
| | pressure | water dispersion type | Heat | Humidity | |
| | (Pa) | pressure-sensitive adhesive | durability | durability | Contrast |
| Example 1 | 10 | 2.98 | 3 | 5 | 2.600 |
| Example 2 | 5 | 1.95 | 4 | 5 | 2.709 |
| Example 3 | 2 | 0.92 | 5 | 5 | 3.000 |
| Example 4 | 1 | 0.23 | 5 | 5 | 3.250 |
| Example 5 | 0.8 | 0.06 | 5 | 4 | 2.800 |
| Example 6 | 0.6 | 0.03 | 5 | 3 | 2.647 |
| Comparative | 40 | 3.5 | 2 | 5 | 2.369 |
| Example 1 | | | | | |
| Comparative | 50 | 5.23 | 2 | 5 | 2.000 |
| Example 2 | | | | | |
| Comparative | Untreated | 6.50 | 1 | 5 | 1.666 |
| Example 3 | | | | | |
| Comparative | 0.1 | 0.01 | 5 | 2 | 1.833 |
| Example 4 | | | | | |

TABLE 2

| | | Pressure-sensitive | | | |
|---|---|---|---|---|---|
| | | adhesive coating liquid | | | |
| | Degassing | Dissolved oxygen | | | |
| | Reduced | concentration (mg/L) of | Evaluation | | |
| | pressure | organic solvent type | Heat | Humidity | |
| | (Pa) | pressure-sensitive adhesive | durability | durability | Contrast |
| Example 7 | 10 | 2.52 | 4 | 5 | 2.645 |
| Example 8 | 5 | 1.83 | 5 | 5 | 2.783 |
| Example 9 | 3 | 0.54 | 5 | 5 | 3.290 |
| Example 10 | 2 | 0.27 | 5 | 4 | 3.076 |
| Example 11 | 0.5 | 0.06 | 5 | 3 | 2.976 |
| Comparative | Untreated | 5.50 | 2 | 5 | 1.583 |
| Example 5 | | | | | |
| Comparative | 0.1 | 0.01 | 5 | 5 | 1.813 |
| Example 6 | | | | | |

TABLE 3

| | | Pressure-sensitive | | | |
|---|---|---|---|---|---|
| | | adhesive coating liquid | | | |
| | | Dissolved oxygen | | | |
| | Degassing | concentration (mg/L) of | | | |
| | Reduced | radiation-curable, | Evaluation | | |
| | pressure | organic solvent type, | Heat | Humidity | |
| | (Pa) | pressure-sensitive adhesive | durability | durability | Contrast |
| Example 12 | 10 | 2.98 | 4 | 5 | 2.732 |
| Example 13 | 5 | 1.94 | 5 | 5 | 2.845 |
| Example 14 | 3 | 0.68 | 5 | 5 | 3.117 |
| Example 15 | 2 | 0.36 | 5 | 4 | 2.985 |
| Example 16 | 0.5 | 0.08 | 5 | 3 | 2.639 |
| Comparative | Untreated | 6.80 | 2 | 5 | 1.789 |
| Example 7 | | | | | |
| Comparative | 0.1 | 0.01 | 5 | 5 | 1.523 |
| Example 8 | | | | | |

### DESCRIPTION OF REFERENCE CHARACTERS

In the drawings, reference numeral 1 represents a degassing apparatus, 2 a pressure-sensitive adhesive coating liquid, 3 a buffer tank, 4 a connecting pipe, 5 a pump set tank, 7 a vacuum pump, 6 a connecting pipe, 11 a closed tank, 13 a vacuum valve, 31 a closed tank, and 51 a closed tank.

1. A pressure-sensitive adhesive optical film, comprising:
an optical film; and
a pressure-sensitive adhesive layer placed on at least one side of the optical film, wherein
the pressure-sensitive adhesive layer is a product formed by applying a pressure-sensitive adhesive coating liquid having a dissolved oxygen concentration of 0.02 to 3 mg/L and then drying the pressure-sensitive adhesive coating liquid.

2. The pressure-sensitive adhesive optical film according to claim 1, wherein the pressure-sensitive adhesive coating liquid is an aqueous dispersion type pressure-sensitive adhesive comprising a dispersion containing at least a base polymer dispersed in water.

3. The pressure-sensitive adhesive optical film according to claim 1, wherein the aqueous dispersion type pressure-sensitive adhesive has a dissolved oxygen concentration of 0.05 to 2 mg/L.

4. The pressure-sensitive adhesive optical film according to claim 1, wherein the aqueous dispersion type pressure-sensitive adhesive has a dissolved oxygen concentration of 0.1 to 1 mg/L.

5. The pressure-sensitive adhesive optical film according to claim 1, wherein the aqueous dispersion type pressure-sensitive adhesive has a dissolved oxygen concentration of 0.1 to 0.5 mg/L.

6. The pressure-sensitive adhesive optical film according to claim 2, wherein the base polymer in the aqueous dispersion type pressure-sensitive adhesive is a (meth)acryl-based polymer.

7. The pressure-sensitive adhesive optical film according to claim 6, wherein the (meth)acryl-based polymer as the base polymer is a product of emulsion polymerization.

8. The pressure-sensitive adhesive optical film according to claim 1, wherein the pressure-sensitive adhesive coating liquid is an organic solvent type pressure-sensitive adhesive comprising a solution containing at least a base polymer dissolved in an organic solvent.

9. The pressure-sensitive adhesive optical film according to claim 8, wherein the organic solvent type pressure-sensitive adhesive has a dissolved oxygen concentration of 0.1 to 2 mg/L.

10. The pressure-sensitive adhesive optical film according to claim 8, wherein the organic solvent type pressure-sensitive adhesive has a dissolved oxygen concentration of 0.5 to 1 mg/L.

11. A method for manufacturing the pressure-sensitive adhesive optical film according to claim 1, comprising the steps of:
(1) degassing a pressure-sensitive adhesive coating liquid so that the coating liquid has a dissolved oxygen concentration of 0.02 to 3 mg/L;
(2) applying the pressure-sensitive adhesive coating liquid, which has undergone the degassing step (1), to one or both sides of a base substrate; and
(3) drying the applied pressure-sensitive adhesive coating liquid to form a pressure-sensitive adhesive layer.

12. An image display, comprising at least one piece of the pressure-sensitive adhesive optical film according to claim 1.

13. A pressure-sensitive adhesive coating liquid for use in forming a pressure-sensitive adhesive layer of a pressure-sensitive adhesive optical film comprising an optical film and the pressure-sensitive adhesive layer placed on at least one side of the optical film,
the pressure-sensitive adhesive coating liquid has a dissolved oxygen concentration of 0.02 to 3 mg/L.

14. A method for producing the pressure-sensitive adhesive coating liquid according to claim 13, comprising degassing a pressure-sensitive adhesive coating liquid so that the coating liquid has a dissolved oxygen concentration of 0.02 to 3 mg/L.
